(19) United States
(12) Patent Application Publication
(10) Pub. No.: US 2011/0032244 A1
(43) Pub. Date: Feb. 10, 2011

(54) LIGHT-EMITTING ELEMENT DRIVE DEVICE AND LIGHT-EMITTING DEVICE

(76) Inventor: Shinichiro KATAOKA, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/909,068

(22) Filed: Oct. 21, 2010

Related U.S. Application Data
(63) Continuation of application No. PCT/JP2010/001492, filed on Mar. 4, 2010.

(30) Foreign Application Priority Data
Jun. 30, 2009 (JP) 2009-155497

(51) Int. Cl. G09G 5/00

(52) U.S. Cl. 345/212

(57) ABSTRACT

Power loss and heat output are reduced in a current drive circuit unit of a light-emitting element. A light-emitting element drive device drives N (where N is an integer of 1 or more) light-emitting element groups, and includes a drive voltage generating circuit used as a feedback path of a minimum voltage detection circuit, N current drive circuits, and N or fewer voltage adjustment circuits. The N light-emitting element groups each include at least one light-emitting element. The drive voltage generating circuit supplies a specified voltage from a voltage source to the N light-emitting element groups. The N current drive circuits the N light-emitting element groups by current through the voltage adjustment circuits. Of the N current drive circuits connected to the minimum voltage detection circuit, the current drive circuit with the lowest end voltage is used in the feedback loop of the drive voltage generating circuit. Even if there is a voltage difference between the end voltages of the light-emitting element groups, the end voltage of the current drive circuit is reduced by the voltage adjustment circuit to a voltage equal to or greater than the minimum voltage required for the current drive circuit to operate.

This is a continuation application of International Application No. PCT/JP2010/001492, filed Mar. 4, 2010.

### BACKGROUND OF THE INVENTION

1. Technical Field

The present invention relates to a drive device that drives a light-emitting element, and relates more particularly to a light-emitting element drive device and light-emitting device that drive a light-emitting element such as an LED (light-emitting diode) using a DC/DC converter as a supply voltage source.

2. Related Art

To reduce power loss in the current drive unit and reduce heat buildup in the chips rendered on the same semiconductor substrate, Japanese Unexamined Patent Appl. Pub. JP-A-2007-242477 teaches the configuration of a light-emitting element drive device according to the related art as shown in FIG. 10.

Referring to FIG. 10, the current drive circuits 111A, 111B, 111C current drive light-emitting element groups 110A, 1106, 110C. Each of the light-emitting element groups 110A, 110B, 110C includes a plurality of LEDs, and the plurality of LEDs are series connected so that drive current flows forward from the anode to the cathode. Voltage drop detection circuits 112A, 112B, 112C are respectively connected to the three contact nodes between the element groups 110A, 1108, 110C and the current drive circuits 111A, 111B, 111C. The voltage drop detection circuits 112A, 112B, 112C detect the voltage at the respective nodes, and send a detection signal to the control signal generating unit 116. The control signal generating unit 116 identifies which of the light-emitting element groups 110A, 110B, 110C has the greatest voltage drop, and thus identifies the light-emitting element group with the highest current draw. The control signal generating unit 116 controls the power conversion unit 117 so that the end voltages of the current drive circuit driving the identified light-emitting element group is the lowest voltage required to normally drive the light-emitting element group.

More specifically, the control signal generating unit 116 optimizes the voltage at the three connection nodes using a feedback loop including the power conversion unit 117, light-emitting element groups 110A, 1108, 110C, and voltage drop detection circuits 112A, 112B, 112C. As a result, output problems caused by insufficient current drive circuit power can be eliminated because the end voltages of the current drive circuits 111A, 111B, 111C are equal to or greater than the minimum required power level. In addition, because the end voltages of the current drive circuits 111A, 111B, 111C are low, heat and wasted power consumption by the current drive circuits can be reduced, and the LEDs can be driven efficiently.

As described above, the light-emitting element drive device according to the related art identifies which of a plurality of parallel current drive circuits has the highest current flow and the lowest voltage at the connection node between the light-emitting element group and the current drive circuit. As a result, the light-emitting element drive device according to the related art is configured set the end voltages of the identified current drive circuit to the lowest voltage required.

However, the light-emitting element drive device according to the related art has problems such as described below.

For example, three light-emitting element groups are configured with the same types of LEDs, each of the light-emitting element groups has the same number of LEDs connected in series, and the three current drive circuits are set to the same drive current level. Even with this configuration, however, the sum of the forward voltage in each of the light-emitting element groups (the “total forward voltage” below) may vary due to variations in the forward voltage between LEDs. As a result, the end voltages of the three current drive circuits differ from each other. Because the lowest voltage of the end voltages of the three current drive circuits is the minimum voltage required to current drive the light-emitting element groups, the other end voltages exceeding this minimum voltage are greater than or equal to the required voltage. In addition, if the variation in the forward voltage between LEDs increases, power loss increases in the three current drive circuits.

For example, consider a configuration in which each light-emitting element group has four LEDs connected in series, and the forward voltage of each LED varies in a range of 3.1 V±0.3 V. In addition, the drive current is 100 mA in each of the three current drive circuits, and the lowest voltage of the end voltages of the three current drive circuits is the 0.5 V of the first current drive circuit. In this configuration the variation in the end voltages is greatest when the forward voltage of the four LEDs in the first light-emitting element group driven by the first current drive circuit is 3.1 V+0.3 V, and the forward voltage of the eight LEDs in the second and third light-emitting element groups is 3.1 V−0.3 V. The end voltages of the second and third current drive circuits are therefore described by equation (1).

0.5 V+{(3.1 V+0.3 V)−(3.1 V−0.3 V)}×4=2.9 V (1)

As a result, power consumption by the three current drive circuits is as shown in equation (2), and is significantly greater than the power consumption when the forward voltage of all LEDs is the same as shown in equation (3). The 480 mW difference in power obtained by equations (2) and (3) represents the power loss of the current drive circuits.

0.5 V×100 mA+2.9 V×100 mA×2=630 mW (2)

0.5 V×100 mA×3=150 mW (3)

When the number of light-emitting element groups increases and the number of current drive circuits increases accordingly, the percentage of the number of current drive circuits that are affected by variations in the forward voltage increases as will be understood from equation (2), and as a result power loss represents a greater percentage of the total power consumption of the current drive circuits.

As a result, power loss is often actually reduced by using LEDs with a forward voltage variation of approximately 0.2 V per LED, for example. Selecting LEDs of this class, however, increases the LED procurement cost. In addition, there is a limit to how much the range of variation in the forward voltage can be narrowed by using a specific class of devices, and significant power loss occurs when compared with the ideal power consumption shown in equation (3).

In addition, when the drive current levels of the plural current drive circuits differ as described above, or when the type of LEDs or the number of LEDs connected in series in plural light-emitting element groups differ, the difference in the total forward voltage of the different light-emitting element groups increases. As a result, power loss increases further.

### SUMMARY OF THE INVENTION

A light-emitting element drive device and a light-emitting device according to the present invention are directed to solving the foregoing problem by reducing current drive circuit power loss that increases due to variation in the forward voltage of the light-emitting elements.

A first aspect of the invention is a light-emitting element drive device that drives N (where N is an integer of 2 or more) light-emitting element groups each including one or more light-emitting element, including: a drive voltage generating circuit that supplies a drive voltage to the N light-emitting element groups; N current drive circuits that respectively drive the N light-emitting element groups; and N or fewer voltage adjustment circuits that are disposed to paths between the output of the drive voltage generating circuit and the N current drive circuits, connected in series to the N light-emitting element groups, and adjust the end voltages of the current drive circuits.

In another aspect of the invention, the light-emitting element drive device also has a minimum voltage detection circuit that detects the lowest voltage of the end voltages of the N current drive circuits, and the signal path of the minimum voltage detected by the minimum voltage detection circuit is a feedback path of the drive voltage generating circuit.

In a light-emitting element drive device according to another aspect of the invention, the N or fewer voltage adjustment circuits each include at least an operating amplifier and a transistor, the transistor is connected in series with the N light-emitting element groups on a path between the output of the drive voltage generating circuit and the N current drive circuits; and a feedback circuit (feedback loop) is rendered by inputting a first specific voltage that can change a set voltage for each operating amplifier to one input of the operating amplifier, connecting the other input of the operating amplifier to a path between the N light-emitting element groups and the N current drive circuits, and controlling the transistor by means of the output of the operating amplifier.

In a light-emitting element drive device according to another aspect of the invention, the drive voltage generating circuit includes an error amplifier to which a second specified voltage is input to one input and the output signal of the minimum voltage detection circuit is input to another input, and the drive voltage generating circuit sets the first specified voltage greater than or equal to a third specified voltage that is determined based on the second specified voltage and is the lowest voltage of the end voltages of the N current drive circuits detected by the minimum voltage detection circuit.

In a light-emitting element drive device according to another aspect of the invention, the N or fewer voltage adjustment circuits each include at least a comparator, a transistor, and a resistance component (or diode), the transistor and resistance component (or diode) are connected parallel to each other and connected in series with the N light-emitting element groups on a path between the drive voltage generating circuit and the N current drive circuits, and the transistor is controlled by output from the comparator, of which one input is a path between the N light-emitting element groups and the N current drive circuits and the other input is a fourth specific voltage.

In a light-emitting element drive device according to another aspect of the invention, the N or fewer voltage adjustment circuits each include at least a comparator and a first transistor and a second transistor having a different on resistance, the first transistor and second transistor connected parallel to each other and connected in series with the N light-emitting element groups on a path between the drive voltage generating circuit and the N current drive circuits. The first transistor and second transistor are, or one of the first transistor and second transistor is, controlled by output from the comparator of which the path between the N light-emitting element groups and the N current drive circuits is one input and the other input is a fourth specific voltage.

In a light-emitting element drive device according to another aspect of the invention, the drive voltage generating circuit includes an error amplifier to which the second specified voltage is input to one input and the output signal of the minimum voltage detection circuit is input to another input, and the drive voltage generating circuit sets the fourth specified voltage greater than a third specified voltage that is determined based on the second specified voltage and is the lowest voltage of the end voltages of the N current drive circuits detected by the minimum voltage detection circuit.

Another aspect of the invention is a light-emitting device including N (where N is an integer of 2 or more) light-emitting element groups each including one or more light-emitting element; and the light-emitting element drive device described above.

### EFFECT OF THE INVENTION

With the light-emitting element drive device and light-emitting device according to the invention, the voltage adjustment circuit can absorb differences in the total forward voltages of N light-emitting element groups that differ greatly from each other due to variations in the forward voltages of the light-emitting elements. As a result, the voltage adjustment circuit can control the end voltages of the N current drive circuits to the minimum voltage required to achieve the desired output from the light-emitting element groups. Because a voltage that is higher than necessary is therefore not applied to the ends of the current drive circuits, power loss in the current drive circuits is extremely low and the power consumption of the current drive circuits can be reduced to the minimum required.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a circuit diagram showing the configuration of a light-emitting element drive device according to a first embodiment of the invention.

FIG. 2 is a circuit diagram showing the configuration of a light-emitting element drive device according to a first variation of the first embodiment of the invention.

FIG. 3 is a circuit diagram showing the configuration of a light-emitting element drive device according to a second variation of the first embodiment of the invention.

FIG. 4 is a circuit diagram showing the configuration of a light-emitting element drive device according to a third variation of the first embodiment of the invention.

FIG. 5 is a circuit diagram showing the configuration of a light-emitting element drive device according to a fourth variation of the first embodiment of the invention.

FIG. 6 is a circuit diagram showing the configuration of a light-emitting element drive device according to a second embodiment of the invention.

FIG. 7 is a circuit diagram showing the configuration of a light-emitting element drive device according to a first variation of the second embodiment of the invention.

FIG. 8 is a circuit diagram showing the configuration of a light-emitting element drive device according to a second variation of the second embodiment of the invention.

FIG. 9 is a circuit diagram showing the configuration of a light-emitting element drive device according to a second embodiment of the invention.

FIG. 10 is a circuit diagram showing the configuration of a light-emitting element drive device according to the related art.

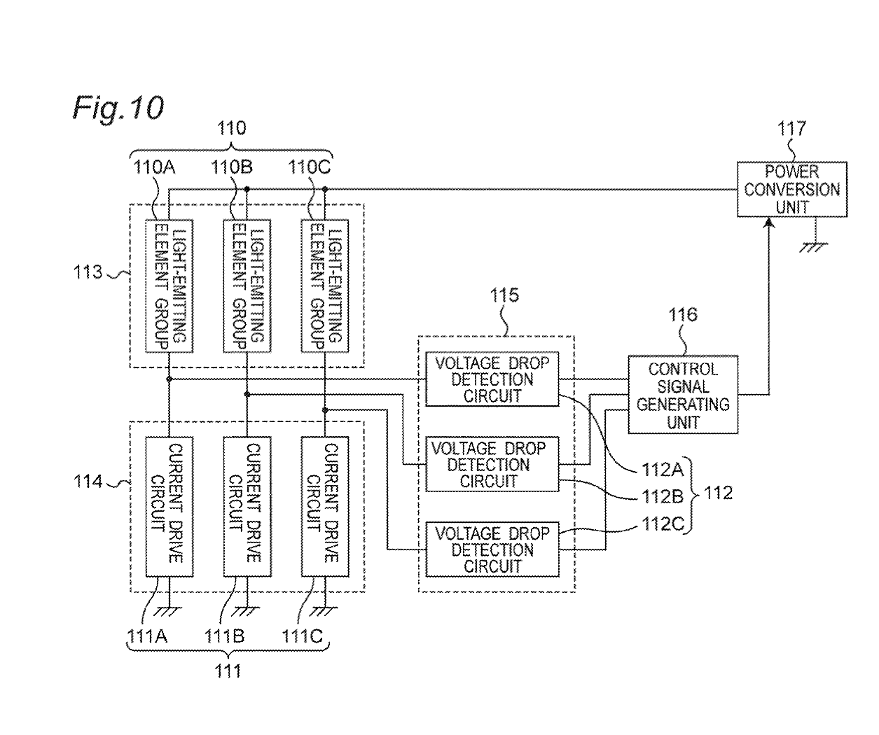

### DETAILED DESCRIPTION OF THE PREFERRED EMBODIMENTS

Preferred embodiments of the present invention are described below with reference to the accompanying figures. Elements in the figures representing an effectively same configuration, operation, and effect are identified by the same reference numerals. Reference numerals used in the figures are also used in the equations as variables denoting the size of the signal represented by the reference numeral.

### Embodiment 1

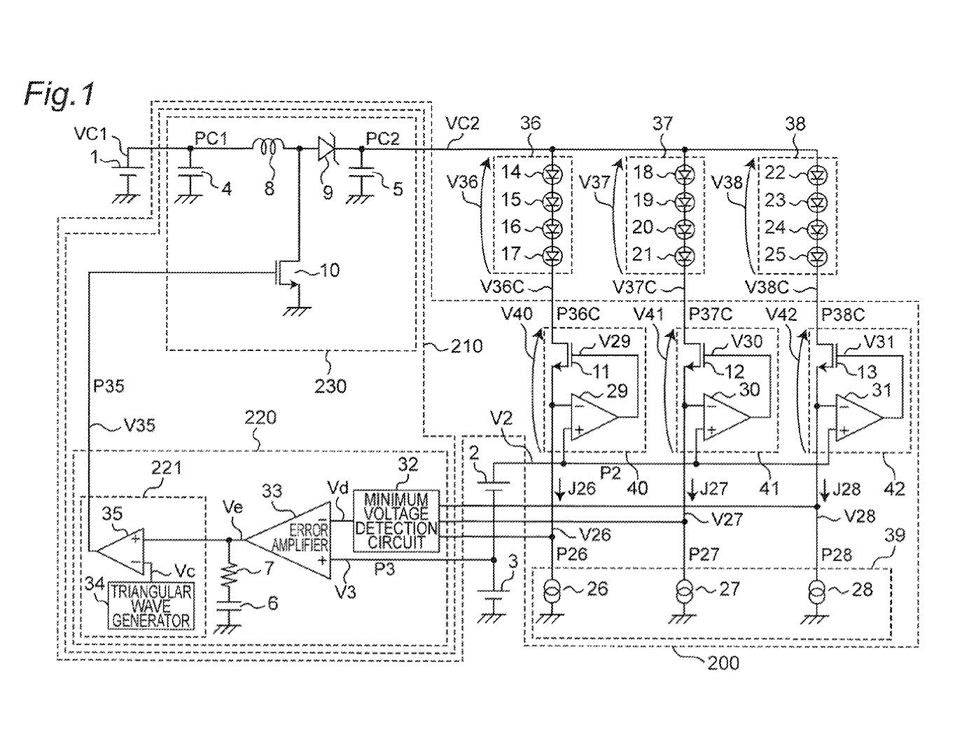

FIG. 1 is a circuit diagram showing the configuration of a light-emitting element drive device 200.

The light-emitting element drive device 200 includes, drive voltage generating circuit 210, voltage adjustment circuit 40, 41, and 42, current drive circuit group 39, cathode paths P36C, P37C, and P38C, detection paths P26, P27, and P28, and voltage source path P2. The light-emitting element drive device 200 drives and causes the light-emitting element groups 36, 37, and 38 to emit. The current drive circuit group 39 includes current drive circuits 26, 27, and 28. The drive voltage generating circuit 210 includes converter control circuit 220, DC/DC converter 230, and control path P35.

The light-emitting element group 36 includes light-emitting elements 14, 15, 16, and 17. Light-emitting element group 37 includes light-emitting elements 18, 19, 20, and 21. Light-emitting element group 38 includes light-emitting elements 22, 23, 24, and 25. Each of the light-emitting elements in this embodiment of the invention is rendered by an LED (light-emitting diode), for example.

The anodes of the light-emitting element groups 36-38 are connected to the output path PC2 of the DC/DC converter 230. The cathodes of the light-emitting element groups 36-38 are connected to cathode paths P36C-P38C, respectively. The light-emitting elements 14-17 are connected together in series so that the forward direction from the anode to the cathode is from output path PC2 to cathode path P36C. The light-emitting elements in the other light-emitting element groups 37-38 are connected in the same way as in light-emitting element group 36.

The voltage adjustment circuit 40 includes an n-channel MOS (negative channel metal oxide semiconductor) transistor 11 and operating amplifier 29.

The voltage adjustment circuit 41 includes n-channel MOS transistor 12 and operating amplifier 30.

Voltage adjustment circuit 42 includes n-channel MOS transistor 13 and operating amplifier 31.

In voltage adjustment circuit 40, the drain of n-channel MOS transistor 11 is connected to cathode path P36C, and the source is connected to detection path P26 and to the inverted input node of the operating amplifier 29. The non-inverted input of the operating amplifier 29 is connected to voltage source path P2, and the output node is connected to the gate of the n-channel MOS transistor 11.

The n-channel MOS transistor and operating amplifier of voltage adjustment circuits 41 and 42 are connected in the same way as in voltage adjustment circuit 40.

One end of each of the current drive circuits 26-28 is connected to a detection path P26-P28, and the other end goes to ground. As a result, light-emitting element groups 36, Cathode paths P36C, voltage adjustment circuit 40 (more specifically, the n-channel MOS transistor 11 contained in the voltage adjustment circuit 40), detection paths P26, and current drive circuits 26 are connected together in series between output path PC2 and ground. Likewise, light-emitting element groups 37, cathode paths P37C, voltage adjustment circuit 41 (more specifically, the n-channel MOS transistor 12 contained in the voltage adjustment circuit 41), detection paths P27, and current drive circuits 27 are connected together in series. Likewise, light-emitting element groups 38, cathode paths P38C, voltage adjustment circuit 42 (more specifically, the n-channel MOS transistor 13 contained in the voltage adjustment circuit 42), detection paths P28, and current drive circuits 28 are connected together in series.

The drive voltage generating circuit 210 generates and supplies drive voltage VC2 through output path PC2 to the light-emitting element groups 36-38. The sum of the forward voltages of the four light-emitting element groups in light-emitting element group 36 is referred to as total forward voltage V36. Likewise, the sums of the forward voltages in light-emitting element groups 37-38 are referred to as total forward voltage V37 and V38, respectively.

The voltages between cathode paths P36C-P38C and ground are referred to as cathode voltages V36C, V37C, and V38C, respectively.

Light-emitting element group 36 divides drive voltage VC2 into total forward voltage V36 and cathode voltage V36C. Likewise, light-emitting element group 37 divides drive voltage VC2 into total forward voltage V37 and cathode voltage V37C. Further similarly, light-emitting element group 38 divides drive voltage VC2 into total forward voltage V38 and cathode voltage V38C.

The voltages between the detection paths P26-P28 and ground (that is, the end voltages of the current drive circuits 27-28) are referred to as end voltages V26, V27, and V28, respectively.

The voltage drop in the voltage adjustment circuit 40, that is, the cathode voltage V36C minus end voltage V26, is referred to as adjustment voltage V40.

Likewise, the voltage drop in the voltage adjustment circuit 41, that is, the cathode voltage V37C minus end voltage V27, is called adjustment voltage V41.

In addition, the voltage drop in voltage adjustment circuit 42, that is, cathode voltage V38C minus end voltage V28, is referred to as adjustment voltage V42.

Voltage adjustment circuit 40 divides cathode voltage V36C into adjustment voltage V40 and end voltage V26.

Likewise, voltage adjustment circuit 41 divides cathode voltage V37C into adjustment voltage V41 and end voltage V27.

Likewise, voltage adjustment circuit 42 divides cathode voltage V38C into adjustment voltage V42 and end voltage V28.

The current drive circuits 26-28 generate drive currents J26, J27, and J28, respectively.

Current drive circuit 26 supplies drive current J26 through detection path P26, voltage adjustment circuit 40, and cathode path P36C to light-emitting element group 36.

Current drive circuits 27-28 similarly supply drive currents J27-J28 through detection paths P27-P28, voltage adjustment circuit 41-42, and cathode paths P37C-P38C to light-emitting element groups 37-38, respectively.

The current drive circuits 26-28 may control drive currents J26-J28 to a respectively specified size. In addition, the current drive circuits 26-28 can output the drive currents J26-J28 as pulse-width modulated currents each having a specified pulse height by means of appropriate on/off control. In this configuration the off-state end voltages V26-V28 are higher than the end voltages V26-V28 in the on state.

The current drive circuit group 39 including current drive circuits 26-28 is rendered on a single semiconductor substrate using a circuit configuration such as a current limiter circuit. The essential elements of the light-emitting element drive device 200 may be rendered on this same semiconductor substrate.

Voltage source 3 is connected between voltage source path P3 and ground, and produces and outputs a specific voltage V3 to the voltage source path P3.

Voltage source 2 is connected between voltage source path P2 and voltage source 3, and by producing a specific voltage outputs a specific voltage V2 representing the voltage sum of the specific voltage V3 and the specific voltage of the voltage source 2 to voltage source path P2. Note that voltage source 2 may be connected between voltage source path P2 and ground, and output specific voltage V2 independently of voltage source 3.

In the voltage adjustment circuit 40, the operating amplifier 29 receives end voltage V26 through the inverted input node, receives the specific voltage V2 from the voltage source path P2 through the non-inverted input node, and by amplifying the difference voltage of specific voltage V2 minus end voltages V26 generates gate control signal V29.

When the n-channel MOS transistor 11 operates in the active region, it receives the gate control signal V29 through the gate and adjusts the drain-source voltage. Because the gate control signal V29 increases as the end voltage V26 becomes smaller than the specific voltage V2, the n-channel MOS transistor 11 lowers the drain-source voltage so that the end voltage V26 rises. Conversely, because the gate control signal V29 drops as the end voltage V26 becomes greater than the specific voltage V2, the n-channel MOS transistor 11 increases the drain-source voltage so that the end voltage V26 drops. Note that the drain-source voltages of the n-channel MOS transistor 11-13 are equal to adjustment voltages V40-V42. The voltage adjustment circuit 40 thus adjusts the adjustment voltage V40 so that the end voltage V26 is substantially equal to specific voltage V2.

Voltage adjustment circuits 41-42 operate in the same way as voltage adjustment circuit 40. That is, operating amplifiers 30, 31 output gate control signals V30 and V31, and n-channel MOS transistors 12-13 receive gate control signals V30-V31 through the gate and adjust the drain-source voltage. As a result, voltage adjustment circuit 41 adjusts adjustment voltage V41 so that end voltage V27 is substantially equal to specific voltage V2, and voltage adjustment circuit 42 adjusts adjustment voltage V42 so that end voltage V28 is substantially equal to specific voltage V2.

Converter control circuit 220 includes a minimum voltage detection circuit 32, error amplifier 33, voltage source path P3, resistor 7, capacitor 6, and PWM (pulse width modulation) control circuit 221.

The minimum voltage detection circuit 32 generates and outputs minimum end voltage Vd to error amplifier 33, the minimum end voltage Vd representing the lowest voltage of end voltages V26-V28.

The minimum voltage detection circuit 32 includes a level shift circuit, and may produce minimum end voltage Vd by level shifting the lowest voltage of end voltages V26-V28.

The error amplifier 33 receives minimum end voltage Vd through the inverted input node, receives specific voltage V3 from voltage source path P3 through the non-inverted input node, and generates error signal Ve by amplifying the voltage difference of specific voltage V3 minus the minimum end voltage Vd.

Resistor 7 and capacitor 6 render a phase compensation filter and adjust the phase of the error signal Ve.

The PWM control circuit 221 includes a triangular wave generator 34 and comparator 35. The triangular wave generator 34 outputs triangular wave signal Vc. The comparator 35 receives the error signal Ve through the non-inverted input node, receives triangular wave signal Vc through the inverted input node, and generates a PWM control signal V35 denoting the result of comparing the error signal Ve and triangular wave signal Vc, and outputs to the control path P35. The PWM control circuit 221 generates the PWM control signal V35 by pulse width modulating a pulse signal that repeats at the period of the triangular wave signal Vc so that the high level period becomes longer as the error signal Ve level rises.

The converter control circuit 220 thus generates and outputs PWM control signal V35 to the control path P35 based on end voltages V26-V28. The high level period of the PWM control signal V35 increases as the minimum end voltage Vd becomes increasingly lower than the specific voltage V3, and the high level period of the PWM control signal V35 becomes shorter as the minimum end voltage Vd becomes increasingly greater than the specific voltage V3.

DC/DC converter 230 includes voltage source path PC1, capacitor 4, inductor 8, n-channel MOS transistor 10, Schottky diode 9, smoothing capacitor 5, and output path PC2. Voltage source 1 is connected between voltage source path PC1 and ground, and capacitor 4 is parallel connected to the voltage source 1. One end of inductor 8 is connected to voltage source path PC1, and the other end is connected to the drain of n-channel MOS transistor 10 and the anode of Schottky diode 9. The source of the n-channel MOS transistor 10 goes to ground, and the gate thereof is connected to control path P35. The cathode of the Schottky diode 9 is connected to one end of the smoothing capacitor 5 and output path PC2, and the other end of the smoothing capacitor 5 goes to ground.

Voltage source 1 generates and outputs specific voltage VC1 to the voltage source path PC1. Capacitor 4 suppresses variation in the specific voltage VC1 on the voltage source path PC1.

The n-channel MOS transistor 10 receives the PWM control signal V35 from the control path P35 through the gate, and is switched on/off by the PWM control signal V35.

The inductor 8 charges and discharges power from voltage source 1 as a result of the n-channel MOS transistor 10 switching on and off.

While charging, the Schottky diode 9 prevents backflow from the output path PC2, and passes the discharged power forward when discharging.

The smoothing capacitor 5 stores power passing therethrough, and outputs smoothed drive voltage VC2 to the output path PC2.

The DC/DC converter 230 thus converts specific voltage VC1 to drive voltage VC2, supplies the drive voltage VC2 through output path PC2 to light-emitting element groups 36-3, and adjusts the drive voltage VC2 based on the PWM control signal V35 received through the control path P35. The DC/DC converter 230 is a step-up converter that outputs a drive voltage VC2 that is higher than specific voltage VC1.

Because the on period of the n-channel MOS transistor 10 increases as the high level period of the PWM control signal V35 becomes longer, the charging period of inductor 8 becomes longer and the drive voltage VC2 therefore rises. When the drive voltage VC2 rises, end voltages V26-V28 also rise.

Conversely, because the on period of the n-channel MOS transistor 10 becomes shorter as the high level period of the PWM control signal V35 becomes shorter, the inductor 8 charging time becomes shorter and the drive voltage VC2 therefore drops. When the drive voltage VC2 drops, the end voltages V26-V28 also drop.

As a result of the foregoing operation of the converter control circuit 220, drive voltage VC2 rises as the minimum end voltage Vd becomes lower than the specific voltage V3, the end voltages V26-V28 therefore also rise, and the minimum end' voltage Vd is prevented from becoming lower than specific voltage V3. Conversely, because the drive voltage VC2 decreases as the minimum end voltage Vd becomes greater than the specific voltage V3, the end voltages V26-V28 also drop and the minimum end voltage Vd is prevented from becoming greater than specific voltage V3.

The drive voltage generating circuit 210 thus adjusts the drive voltage VC2 so that the minimum end voltage Vd of the end voltage V26-V28 is substantially equal to specific voltage V3.

Note that below the current drive circuits 26-28 are all on. The power loss of a current drive circuit that is off is zero and does not need to be considered because there is no voltage adjustment by the drive voltage generating circuit 210 or voltage adjustment circuits 40-42. Of the paths from the output path PC2 to the light-emitting element groups 36-38, cathode paths P36C-P38C, voltage adjustment circuit 40-42, and detection paths P26-P28, the path of the minimum end voltage Vd is called the minimum voltage path. The paths other than the minimum voltage path are referred to as the not-minimum voltage path. The number of minimum voltage paths and not-minimum voltage paths is one or more each and a total of 3. The minimum end voltage Vd is made to converge to specific voltage V3 as a result of the light-emitting element drive device 200 controlling operation through a closed-loop through the converter control circuit 220, control path P35, DC/DC converter 230, and minimum voltage path.

The minimum voltage required for the current drive circuits 26-28 to normally produce the desired drive current is called the minimum operating end voltage.

If the specific voltage V3 is set to the minimum operating end voltage, the end voltage of the current drive circuit supplying drive current to the minimum voltage path will be the minimum operating end voltage. In addition, the voltage adjustment circuit on the minimum voltage path does not need to adjust the end voltage, and preferably passes the drive current with minimum power consumption. As a result, by setting the specific voltage V2 slightly higher than the specific voltage V3, the operating amplifier on the minimum voltage path drives the n-channel MOS transistor in a fully on mode (in the saturation region), and the n-channel MOS transistor operates in the full-on state (saturated state). The adjustment voltage of the minimum voltage path at this time is the on voltage of the n-channel MOS transistor. The drive voltage generating circuit 210 adjusts the drive voltage VC2 so that the drive voltage VC2 is equal to the sum of the minimum operating end voltage, the adjustment voltage in the full-on mode, and the total forward voltage of the light-emitting element groups on the minimum voltage path.

The end voltage of the minimum voltage path is the lowest of end voltages V26-V28 because the total forward voltage of the light-emitting element groups on the minimum voltage path is the greatest of total forward voltages V36-V38. That is, on a not-minimum voltage path, the total forward voltage of the light-emitting element group is less than on the minimum voltage path. On the other hand, because the voltage adjustment circuits 40-42 set the end voltages V26-V28 substantially equal to specific voltage V2, the adjustment voltage of the voltage adjustment circuit on the not-minimum voltage path is greater than the adjustment voltage on the minimum voltage path. As thus described, on the not-minimum voltage path, by causing the n-channel MOS transistor to operate in the active region, the voltage adjustment circuit absorbs smaller steps in the total forward voltage than on the minimum voltage path, and can match the end voltage to the end voltage of the minimum voltage path.

As described above, by setting specific voltage V2 slightly higher than specific voltage V3, the light-emitting element drive device 200 is optimally adjusted on a closed loop circuit including a minimum voltage path. As a result, the light-emitting element drive device 200 can match the end voltage of the current drive circuit supplying drive current t the minimum voltage path to the minimum operating end voltage. At the same time, the voltage adjustment circuits 40-42 can adjust the end voltages of the current drive circuits supplying drive current to the not-minimum voltage paths to near the minimum operating end voltage.

An example of the actual operation of the light-emitting element drive device 200 is described next. The specific voltage V3 is 0.5 V, specific voltage V2 is 0.51″V (that is, the output voltage of the voltage source 2 is 0.01 V), drive currents J26-J28 are 100 mA, and the on resistance of n-channel MOS transistor 11-13 is 50 mΩ. The same type of LED is used for light-emitting elements 14-25. Variation in the forward voltage is 2.9 V±0.1 V (with a 100 mA drive current), the forward voltage of the LEDs in light-emitting element group 36 is 3 V, and the forward voltage of the LEDs in light-emitting element groups 37-38 is 2.8 V. The above-described minimum operating end voltage is 0.5 V.

When thus configured, the total forward voltage V36 is 3 V×4=12 V, and total forward voltages V37 and V38 are 2.8 V×4=11.2 V. The path through the light-emitting element group 36, cathode path P36C, voltage adjustment circuit 40, and detection path P26 is the minimum voltage path, and the other two paths through light-emitting element groups 37 and 38 are the not-minimum voltage paths.

The end voltage V26 on the minimum voltage path is equal to specific voltage V3=0.5 V.

The operating amplifier 29 receives the specific voltage V2=0.51 V through the non-inverted input node, receives the end voltage V26=0.5 V through the inverted input node, and the gate control signal V29 is therefore maximized. At this time the n-channel MOS transistor 11 goes to the full-on state (saturation state) with an on resistance of 50 mΩ, and the drain-source voltage (adjustment voltage V40) goes to 50 mΩ×100 mA=5 mV. The cathode voltage V36C is therefore 0.5 V+5 mV=0.505 V, and the drive voltage VC2 is 0.505 V+12 V=12.505 V. The end voltage V27-V28 on the not-minimum voltage path is equal to specific voltage V2 or 0.51 V due to the adjustment function of the voltage adjustment circuit 41-42 operating in the active region.

As a result, power consumption by the current drive circuits 26-28 is as shown in equation (4), and the end voltage of the current drive circuits 26-28 is near the theoretical ideal of 0.5 V shown in equation (5). The power difference between equation (4) and equation (5), that is, the power loss in equation (4), is approximately 2 mW, and is less than 2% of total power consumption.

0.5 V×100 mA+0.51 V×100 mA×2=152 mW (4)

0.5 V×100 mA×3=150 mW (5)

In addition, because end voltage V26 is 0.5V, and end voltages V27-V28 are 1.3V when voltage adjustment circuit 40-42 are not used, power consumption in the current drive circuits 26-28 is as shown in equation (6). Power loss in equation (6) is approximately 160 mW, and is greater than 100% of total power consumption. As will be known by comparing equation (4) with equation (6), power loss is greatly reduced by the voltage adjustment circuits 40-42.

0.5 V×100 mA+1.3 V×100 mA×2=310 mW (6)

As described above, the voltage adjustment circuit 40-42 of the light-emitting element drive device 200 can absorb differences in the total forward voltages V36-V38 of the light-emitting element groups, which can differ greatly from each other due to variations in the forward voltage of the light-emitting elements. As a result, the voltage adjustment circuit 40-42 can set all end voltages V26-V28 of the current drive circuits to the lowest voltage required to achieve the desired output from the light-emitting element groups 36-38. As a result, because a voltage that is higher than necessary is not applied to the ends of the current drive circuits, current drive circuit power loss can be significantly reduced, and power consumption by the current drive circuits can be reduced to the minimum required.

When current drive circuits 26-28 are rendered on a single semiconductor substrate, heat output from the semiconductor chip can be reduced, the quality of the semiconductor chip can be improved, and components including more current drive circuits can be rendered on the same semiconductor substrate. In addition, because there is no need to differentiate the light-emitting elements, such selection processes and the cost of the light-emitting element groups can be reduced, and the cost of a light-emitting device including this light-emitting element drive device 200 can be reduced.

In addition to variations in the forward voltage of the light-emitting elements rendering the light-emitting element groups, the total forward voltages V36-V38 of the light-emitting element groups may also differ from each other in the following cases. First, when the drive currents J26-J28 differ from each other. Second, when the number of LEDs connected in series differs in each of the light-emitting element groups 36-38. Third, when types of LEDs with different forward voltages are used in each of the light-emitting element groups 36-38. Fourth, when there is a difference in the ambient temperatures of the light-emitting element groups 36-38. Even in such situations, the total forward voltages V36-V38 differ from each other, and the effect described above can be achieved by the operation of the voltage adjustment circuits 40-42.

The drive current generated by one current drive circuit tends to change dependent upon the end voltages. For example, as the end voltage rises, the drive current tends to increase. However, because the voltage adjustment circuit connected to the current drive circuit can suppress variation in the end voltage, the relative precision of the drive current output by one current drive circuit

In addition, because the minimum end voltage Vd of the three current drive circuits 26-28 is detected from the end voltages of the current drive circuits that are on, the drive current tends to change depending on the specific characteristics of the on current drive circuits. However, regardless of which of the three current drive circuits 26-28 is on, the voltage adjustment circuit connected to the current drive circuit that is on can suppress variation in the end voltage. As a result, the absolute precision of the drive current can be improved in the three current drive circuits 26-28.

Note that when the minimum operating end voltages of the current drive circuits 26-28 differ because the drive currents supplied to the current drive circuits 26-28 differ, the power consumption of the current drive circuits 26-28 can be optimized by each of the operating amplifiers 29-31 receiving a specifically optimized specific voltage through the non-inverted input node.

Note that in the configuration shown in FIG. 1 a voltage adjustment circuit 40-42 is provided for each of the light-emitting element groups 36-38. However, a voltage adjustment circuit is not necessarily required for all of the light-emitting element groups, and a voltage adjustment circuit may be provided only for required light-emitting element groups. For example, if the type of LED (and therefore the forward voltage) differs or the number of LEDs in series differs in each of the light-emitting element groups 36-38, the light-emitting element groups for which using a voltage adjustment circuit would be effective can be determined in advance, and a voltage adjustment circuit provided only for those light-emitting element groups. There are also situations in which the number of light-emitting element groups is large, and providing a voltage adjustment circuit for each light-emitting element group is not always necessary from a cost perspective.

### First Variation of Embodiment 1

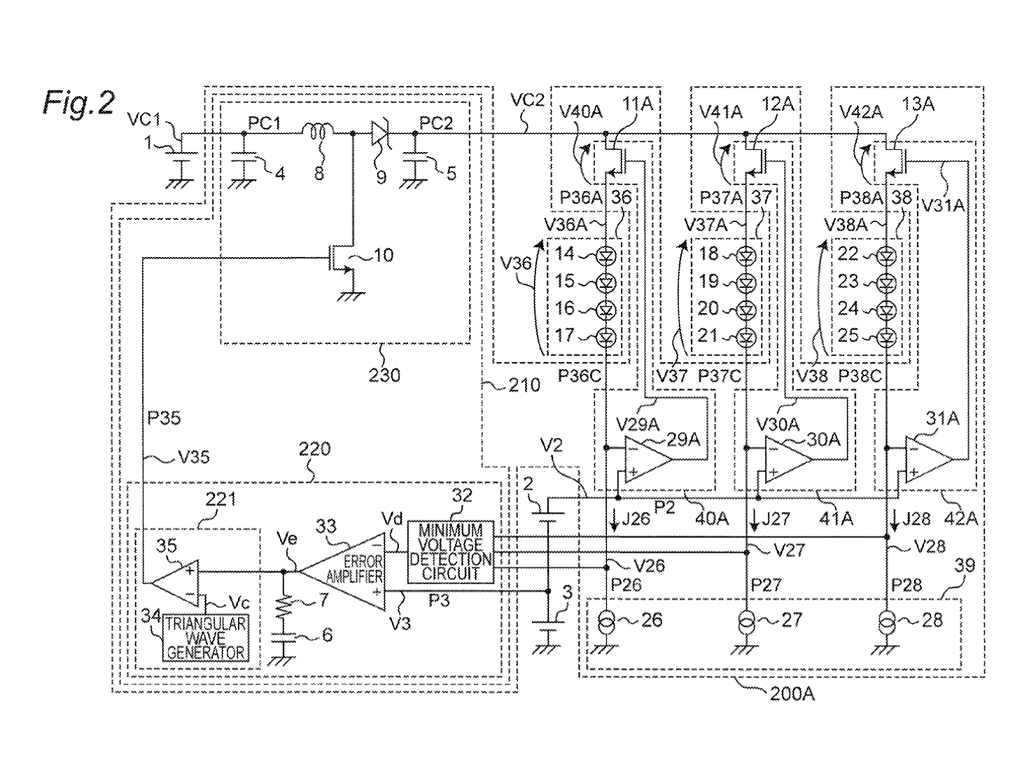

FIG. 2 is a circuit diagram showing the configuration of a light-emitting element drive device 200A. This light-emitting element drive device 200A differs from the light-emitting element drive device 200 shown in FIG. 1 in also having anode paths P36A, P37A, P38A and using voltage adjustment circuits 40A, 41A, 42A instead of voltage adjustment circuits 40-42.

Voltage adjustment circuit 40A includes n-channel MOS transistor 11A and operating amplifier 29A. Voltage adjustment circuit 41A includes n-channel MOS transistor 12A and operating amplifier 30A. Voltage adjustment circuit 42A includes n-channel MOS transistor 13A and operating amplifier 31A.

Anode paths P36A-P38A are connected to the anodes of light-emitting element groups 36-38. In voltage adjustment circuit 40A, the drain of n-channel MOS transistor 11A is connected to output path PC2, and the source is connected to anode path P36A. The inverted input node of operating amplifier 29A is connected to cathode paths P36C and detection paths P26, the non-inverted input node is connected to voltage source path P2, and the output node is connected to the gate of n-channel MOS transistor 11A. The n-channel MOS transistor and operating amplifier in voltage adjustment circuits 41A-42A are connected in the same way as those of voltage adjustment circuit 40A.

The voltages on the anode paths P36A-P38A are referred to respectively as anode voltages V36A, V37A, V38A. The n-channel MOS transistor 11A (that is, voltage adjustment circuit 40A) divides drive voltage VC2 into adjustment voltage V40A and anode voltage V36A. Likewise, n-channel MOS transistor 12A (that is, voltage adjustment circuit 41A) splits drive voltage VC2 into adjustment voltage V41A and anode voltage V37A. Likewise, n-channel MOS transistor 13A (that is, voltage adjustment circuit 42A) divides drive voltage VC2 into adjustment voltage V42A and anode voltage V38A.

Light-emitting element group 36 splits anode voltage V36A into total forward voltage V36 and end voltage V26. Light-emitting element group 37 splits anode voltage V37A into total forward voltage V37 and end voltage V27. Light-emitting element group 38 splits anode voltage V38A into total forward voltage V38 and end voltage V28.

Operating amplifiers 29A-31A output gate control signals V29A, V30A, V31A, respectively. Gate control signals V29A-V31A are each on average a higher voltage than gate control signals V29-V31 shown in FIG. 1.

Voltage adjustment circuit 40A adjusts adjustment voltage V40A and makes end voltage V26 substantially equal to specific voltage V2. Voltage adjustment circuits 41A-42A similarly adjust adjustment voltages V41A-V42A.

Light-emitting element drive device 200A operates identically to the foregoing light-emitting element drive device 200, and has the same effect.

Note that n-channel MOS transistors 11A-13A may be connected between the LEDs in light-emitting element groups 36-38, respectively.

### Second Variation of Embodiment 1

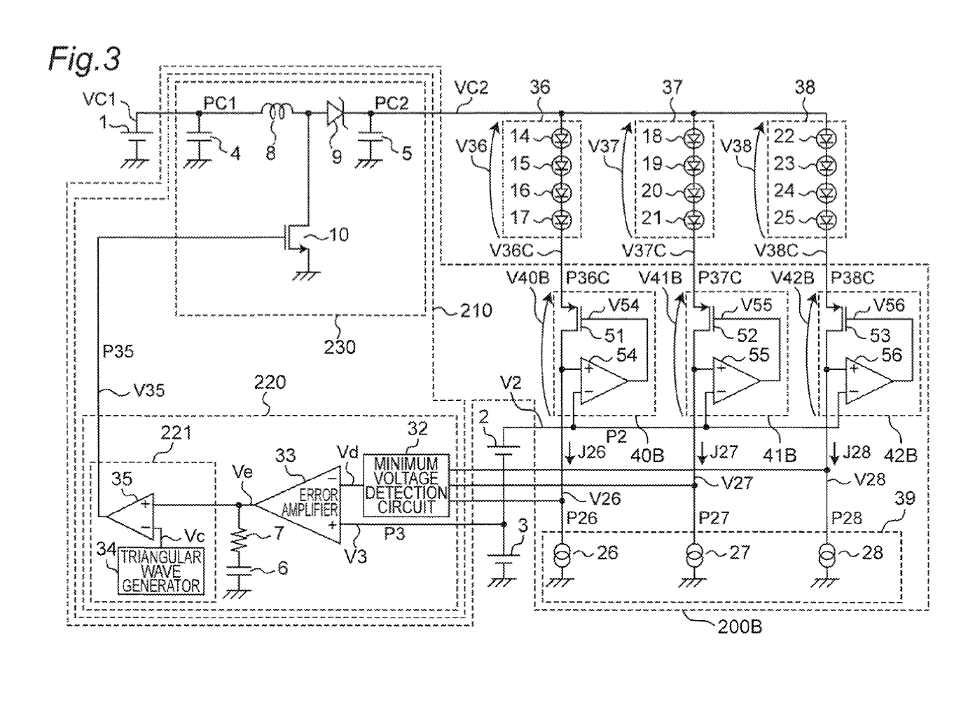

FIG. 3 is a circuit diagram showing the configuration of light-emitting element drive device 200B. This light-emitting element drive device 200B differs from the light-emitting element drive device 200 shown in FIG. 1 in using voltage adjustment circuits 40B, 41B, 42B instead of voltage adjustment circuits 40-42, respectively.

Voltage adjustment circuit 40B includes p-channel MOS (Positive channel Metal Oxide Semiconductor) transistor 51 and operating amplifier 54. Voltage adjustment circuit 41B includes p-channel MOS transistor 52 and operating amplifier 55. Voltage adjustment circuit 42B includes p-channel MOS transistor 53 and operating amplifier 56.

In voltage adjustment circuit 40B the source of p-channel MOS transistor 51 is connected to cathode path P36C, and the drain is connected to detection path P26 and the non-inverted input node of operating amplifier 54. The inverted input node of operating amplifier 54 is connected to voltage source path P2, and the output node is connected to the gate of p-channel MOS transistor 51. The p-channel MOS transistor and operating amplifier in voltage adjustment circuits 41B-42B are connected in the same way as those in voltage adjustment circuit 40B.

Operating amplifiers 54-56 output gate control signals V54, V55, V56, respectively. Gate control signals V54-V56 are the inverse of gate control signals V29-V31 shown in FIG. 1. Voltage adjustment circuit 40B sets adjustment voltage V40B and makes end voltage V26 substantially equal to specific voltage V2. Voltage adjustment circuits 41B-42B similarly adjust adjustment voltages V41B-V42B. Light-emitting element drive device 200B thus operates in the same way as the foregoing light-emitting element drive device 200 and has the same effect.

### Third Variation of Embodiment 1

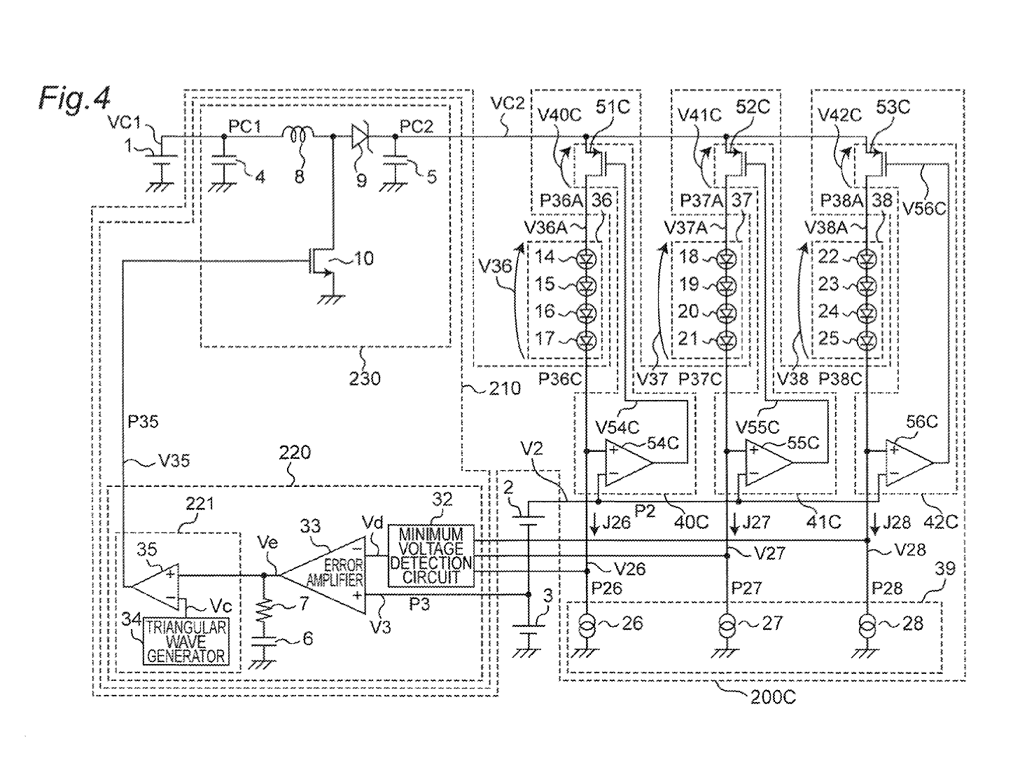

FIG. 4 is a circuit diagram showing the configuration of light-emitting element drive device 200C. This light-emitting element drive device 200C differs from the light-emitting element drive device 200B shown in FIG. 3 in using voltage adjustment circuits 40C, 41C, 42C instead of voltage adjustment circuit 40B-42B.

Voltage adjustment circuit 40C includes p-channel MOS transistor 51C and operating amplifier 54C. Voltage adjustment circuit 41C includes p-channel MOS transistor 52C and operating amplifier 55C. Voltage adjustment circuit 42C includes p-channel MOS transistor 53C and operating amplifier 56C. The p-channel MOS transistors 51C-53C are connected between the output path PC2 and anode paths P36A, P37A, P38A. Operating amplifiers 54C-56C are connected instead of operating amplifiers 54-56 in FIG. 3.

Operating amplifiers 54C-56C output gate control signals V54C, V55C, V56C, respectively. Gate control signals V54C-V56C are each on average a higher voltage than gate control signals V54-V56 in FIG. 3.

Voltage adjustment circuit 40C adjusts adjustment voltage V40C and makes end voltage V26 substantially equal to specific voltage V2. Voltage adjustment circuits 41C-42C similarly adjust adjustment voltages V41C-V42C. Light-emitting element drive device 200C thus operates identically to the foregoing light-emitting element drive device 200B and has the same effect.

Note that p-channel MOS transistors 51C-53C may be connected between the LEDs of the light-emitting element groups 36-38, respectively.

### Fourth Variation of Embodiment 1

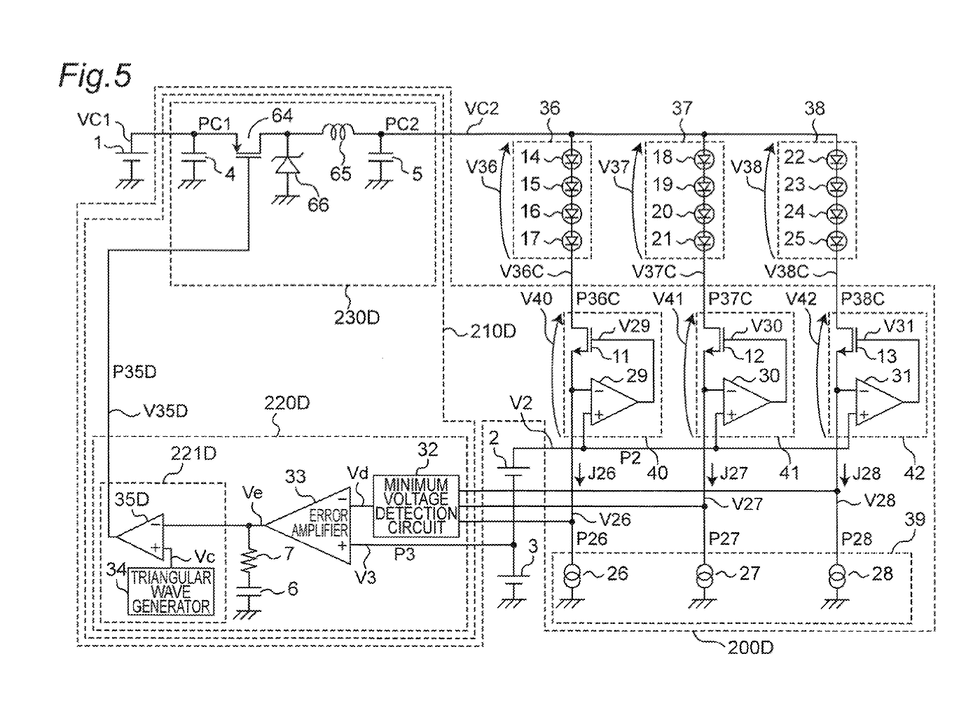

FIG. 5 is a circuit diagram showing the configuration of light-emitting element drive device 200D. This light-emitting element drive device 200D differs from the light-emitting element drive device 200 shown in FIG. 1 in using drive voltage generating circuit 210D instead of drive voltage generating circuit 210.

Drive voltage generating circuit 210D uses converter control circuit 220D instead of the converter control circuit 220 shown in FIG. 1, uses DC/DC converter 230D instead of DC/DC converter 230 in FIG. 1, and has a control path P35D instead of control path P35 in FIG. 1.

Converter control circuit 220D includes PWM control circuit 221D instead of PWM control circuit 221 in FIG. 1.

PWM control circuit 221D includes comparator 35D instead of comparator 35 in FIG. 1.

DC/DC converter 230D uses p-channel MOS transistor 64, Schottky diode 66, and inductor 65 instead of inductor 8, n-channel MOS transistor 10, and Schottky diode 9 in FIG. 1.

The source of p-channel MOS transistor 64 is connected to voltage source path PC1, the gate is connected to control path P35D, and the drain is connected to the anode of Schottky diode 66 and one end of inductor 65. The cathode of Schottky diode 66 goes to ground, and the other end of inductor 65 is connected to output path PC2.

Comparator 35D receives error signal Ve through the inverted input node, receives triangular wave signal Vc through the non-inverted input node, and generates and outputs PWM control signal V35D showing the result of comparing error signal Ve and triangular wave signal Vc to control path P35D.

PWM control circuit 221D generates PWM control signal V35D by adjusting the pulse width of a pulse signal that repeats at the period of triangular wave signal Vc so that the high level period becomes shorter as the error signal Ve rises. The high period of PWM control signal V35D becomes shorter as the minimum end voltage Vd goes lower than specific voltage V3, and the high period of PWM control signal V35D becomes longer as the minimum end voltage Vd rises above specific voltage V3.

The PWM control signal V35D from control path P35D is applied to the gate of p-channel MOS transistor 64, which is turned on/off by PWM control signal V35D.

Inductor 65 charges and discharges power from voltage source 1 when p-channel MOS transistor 64 turns on and off, respectively. Schottky diode 9 cuts inductor 65 from ground while charging, and passes the discharged power forward through ground during power discharge.

DC/DC converter 230D thus converts specific voltage VC1 to drive voltage VC2, supplies drive voltage VC2 through output path PC2 to light-emitting element groups 36-38, and based on the PWM control signal V35D received through control path P35D adjusts drive voltage VC2. The DC/DC converter 230D is a step-down converter that generates a drive voltage VC2 lower than specific voltage VC1.

Because the on period of p-channel MOS transistor 64 becomes longer as the high level period of the PWM control signal V35D become shorter, the inductor 65 charging period becomes longer and, as a result, drive voltage VC2 rises. Conversely, because the on period of p-channel MOS transistor 64 becomes shorter as the high level period of the PWM control signal V35D become longer, the inductor 65 charging period becomes shorter and, as a result, drive voltage VC2 becomes lower.

This light-emitting element drive device 200D can thus control the relationship between error signal Ve and drive voltage VC2 in the same way as the foregoing light-emitting element drive device 200, and can therefore achieve the same effect.

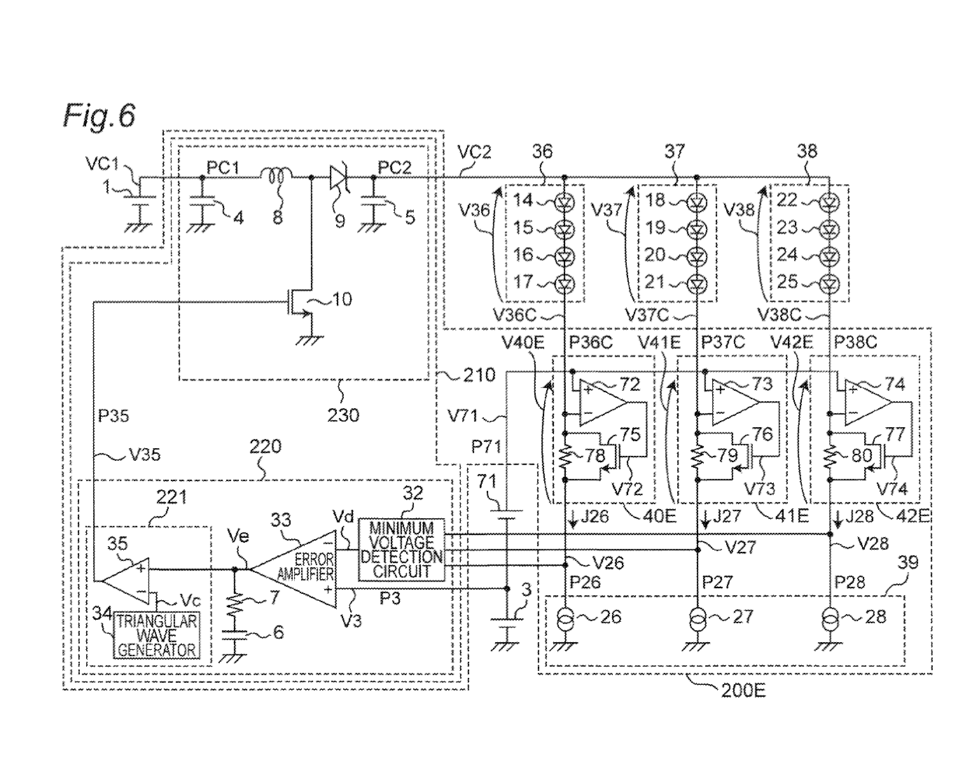

Note, further, that drive voltage generating circuit 210D can also be substituted for the drive voltage generating circuit 210 shown in FIG. 2 to FIG. 4 and in the configurations shown in FIG. 6 to FIG. 9 described below.

### Embodiment 2

FIG. 6 is a circuit diagram showing the configuration of light-emitting element drive device 200E. Light-emitting element drive device 200E differs from the light-emitting element drive device 200 shown in FIG. 1 by using voltage adjustment circuits 40E, 41E, 42E instead of voltage adjustment circuits 40-42, and having voltage source path P71 instead of voltage source path P2. In addition, light-emitting element drive device 200E also uses voltage source 71 shown in FIG. 6 instead of voltage source 2 shown in FIG. 1. Other aspects of the configuration, operation, and effect of this second embodiment of the invention are the same as in the first embodiment, and further description thereof is omitted.

Voltage adjustment circuit 40E includes n-channel MOS transistor 75, resistor 78, and comparator 72. Voltage adjustment circuit 41E includes n-channel MOS transistor 76, resistor 79, and comparator 73. Voltage adjustment circuit 42E includes n-channel MOS transistor 77, resistor 80, and comparator 74.

In voltage adjustment circuit 40E, the drain of n-channel MOS transistor 75 is connected to the inverted input node of comparator 72, one end of resistor 78, and cathode path P36C, and the source is connected to the other end of resistor 78 and detection path P26. The non-inverted input node of comparator 72 is connected to voltage source path P71, and the output node is connected to the gate of n-channel MOS transistor 75. The n-channel MOS transistor and comparator in voltage adjustment circuits 41E-42E are connected in the same way as in this voltage adjustment circuit 40E.

Voltage source 71 is connected between voltage source path P71 and voltage source 3, and by generating a specific voltage outputs specific voltage V71 representing the sum of specific voltage V3 and the specific voltage of voltage source 71 to voltage source path P71. Note that voltage source 71 may be connected between voltage source path P71 and ground independently of voltage source 3 to generate specific voltage V71.

In voltage adjustment circuit 40E, comparator 72 receives cathode voltage V36C through the inverted input node, receives specific voltage V71 from voltage source path P71 through the non-inverted input node, and generates gate control signal V72 denoting the result of comparing cathode voltage V36C and specific voltage V71.

The n-channel MOS transistor 75 turns on/off according to the gate control signal V72 applied to the gate thereof.

When cathode voltage V36C is greater than specific voltage V71, gate control signal V72 goes low and the n-channel MOS transistor 75 turns off. As a result, voltage adjustment circuit 40E sets adjustment voltage V40E to the product of drive current J26 and resistance 78. When cathode voltage V36C is lower than specific voltage V71, gate control signal V72 is high and n-channel MOS transistor 75 turns on. As a result, voltage adjustment circuit 40E sets the adjustment voltage V40E to the product of drive current J26 and the on resistance of n-channel MOS transistor 75 (that is, the on voltage of n-channel MOS transistor 75).

Voltage adjustment circuits 41E-42E operate in the same way as voltage adjustment circuit 40E. That is, comparators 73-74 generate gate control signals V73-V74, respectively. The n-channel MOS transistors 76-77 are turned on/off by the receive gate control signals V73-V74 received through the gate. Similarly to voltage adjustment circuit 40E, voltage adjustment circuits 41E-42E adjust adjustment voltages V41E-V42E.

The n-channel MOS transistor is on the minimum voltage path and is off on the not-minimum voltage path. As a result, as in the configurations shown in FIG. 1 to FIG. 5 (first embodiment), the adjustment voltage on the minimum voltage path is the on voltage of the MOS transistor.

The drive voltage generating circuit 210 adjusts the end voltage of the minimum voltage path to the minimum operating end voltage. At the same time, the drive voltage generating circuit 210 adjusts drive voltage VC2 so that the drive voltage VC2 is equal to the sum of the minimum operating end voltage, the adjustment voltage when on, and the total forward voltage of the minimum voltage path.

The resistance of resistors 78-80 is set so that the product of the resistance and the drive current is less than the adjusted drive voltage VC2 minus the minimum operating end voltage and the total forward voltage of the not-minimum voltage path. In addition, the resistance of resistors 78-80 is set to be higher than the on voltage of the n-channel MOS transistor. The specific voltage V71 is set greater than the cathode voltage on the minimum voltage path and less than the cathode voltage on the not-minimum voltage path.

As a result of these settings, the n-channel MOS transistor is on the minimum voltage path and is off on the not-minimum voltage path. In addition, on the not-minimum voltage path, the voltage adjustment circuit reduces the end voltage toward the minimum operating end voltage. Note that due to variation in the forward voltage of the light-emitting element groups on the not-minimum voltage path, the n-channel MOS transistor on the not-minimum voltage path may be on.

A specific example of the operation of the light-emitting element drive device 200E is described next.

In this example specific voltage V3 is 0.5 V, specific voltage V71 is 0.9 V (that is, the voltage output by voltage source 71 is 0.4 V), drive currents J26-J28 are 100 mA, and the on resistance of n-channel MOS transistors 75-77 is 50 mΩ. The same type of LED is used for the light-emitting elements 14-25. Variation in the forward voltage is 2.9 V±0.1 V (with a 100 mA drive current), the forward voltage of the LEDs in light-emitting element groups 36 is 3V, and the forward voltage of the LEDs in light-emitting element groups 37-38 is 2.8 V. In addition, the foregoing minimum operating end voltage is 0.5 V, and the resistance of resistors 78-80 is 4Ω.

When thus configured, total forward voltage V36 is 3 V×4=12 V, and total forward voltages V37 and V38 are 2.8 V×4=11.2 V. The path through light-emitting element groups 36, cathode paths P36C, voltage adjustment circuit 40E, and detection paths P26 is the minimum voltage path, and the two other paths through the other light-emitting element groups 37 and 38 are the not-minimum voltage paths. The end voltage V26 on the minimum voltage path is equal to specific voltage V3=0.5 V. The n-channel MOS transistor 75 is on (saturation state) with a 50 mΩ on resistance, and the drain-source voltage (adjustment voltage V40E) is 50 mΩ×100 mA=5 mV. Because resistance 78 is sufficiently greater than the on resistance, its effect on the adjustment voltage V40E can be eliminated. Therefore, cathode voltage V36C is 0.5 V+5 mV=0.505V, and drive voltage VC2 is 0.505 V+12 V=12.505 V. Cathode voltages V37C-V38C on the not-minimum voltage path are 12.505 V−11.2 V=1.305 V. Comparators 73-74 receive specific voltage V71=0.9 V through the non-inverted input node, and receive cathode voltages V37C-V38C=1.305 V through the inverted input node, and gate control signal V72 therefore goes low. Therefore, n-channel MOS transistors. 76-77 turn off, and end voltages V27-V28 go to 1.305 V−4Ω×100 mA=0.905 V.

Power consumption by the current drive circuits 26-28 can thus be determined from equation (7), and while power loss reduction is less than that obtained from equation (4) in the first embodiment, power loss is reduced compared with a configuration not having voltage adjustment circuits 40E-42E as shown in equation (6).

0.5 V×100 mA+0.905 V×100 mA×2=231 mW (7)

Setting the voltage source 71 to 0.4V and resistors 78-80 to 4Ω enable absorbing half or approximately 0.4 V of the 0.8 V variation in the total forward voltage V36-V38 of 12V-11.2V in the end voltages V26-V28. When the cathode voltages V36C-V38C are approximately 0.4 V greater than the 0.5 V minimum operating end voltage, the voltage adjustment circuits 41E-42E lower the end voltages V27-V28 0.4 V as a result of the voltage step-down by the 4-Ω resistance. Note that these settings can be changed as desired according to the conditions.

As described above, light-emitting element drive device 200E reduces the end voltage V26-V28 of current drive circuits 26-28 and reduces the power consumption of the current drive circuits by the operation of voltage adjustment circuits 40E-42E rendered with comparators that are lower in cost than operating amplifiers.

Note that when the minimum operating end voltages of current drive circuits 26-28 differ because the drive current levels of the current drive circuits 26-28 are different, comparators 72-74 may receive different optimized specific voltages through the non-inverted input nodes thereof to optimize the power consumption of the current drive circuits 26-28.

Note, further, that the connections of the non-inverted input nodes and the inverted input nodes of the comparators 72-74 may be interchanged, and n-channel MOS transistors 75-77 may be replaced by p-channel MOS transistors.

Note, further, that resistors 78-80 may be replaced with MOS transistors having an equivalent on resistance, or with diodes that produce the equivalent voltage drop.

### First Variation of Embodiment 2

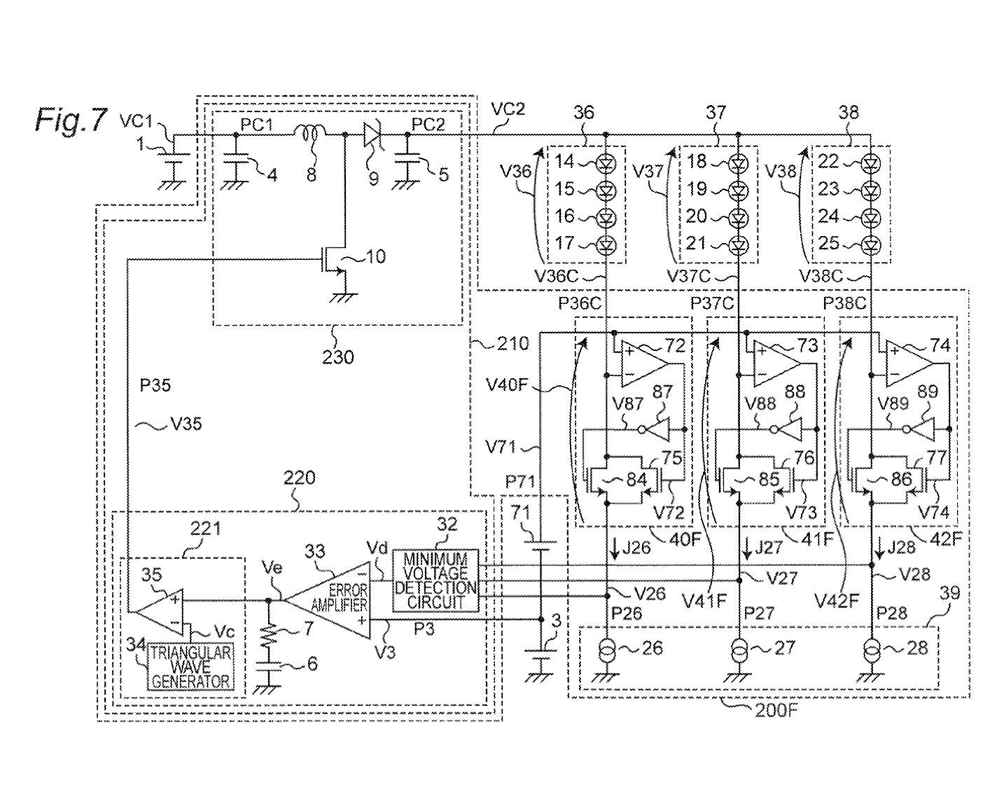

FIG. 7 is a circuit diagram showing the configuration of a light-emitting element drive device 200F. Light-emitting element drive device 200F differs from the light-emitting element drive device 200E shown in FIG. 6 by using voltage adjustment circuits 40F, 41F, 42F instead of voltage adjustment circuits 40E-42E.

Voltage adjustment circuit 40F includes n-channel MOS transistor 75, n-channel MOS transistor 84, NOT circuit 87, and comparator 72. Voltage adjustment circuit 41F includes n-channel MOS transistor 76, n-channel MOS transistor 85, NOT circuit 88, and comparator 73. Voltage adjustment circuit 42F includes n-channel MOS transistor 77, n-channel MOS transistor 86, NOT circuit 89, and comparator 74.

In voltage adjustment circuit 40F the drains of n-channel MOS transistor 75 and n-channel MOS transistor 84 are connected to the inverted input node of comparator 72 and cathode path P36C. The sources of n-channel MOS transistor 75 and n-channel MOS transistor 84 are connected to detection path P26. The non-inverted input node of comparator 72 is connected to voltage source path P71, and the output nodes are connected to the gate of n-channel MOS transistor 75 and the input node of NOT circuit 87. The output node of the NOT circuit 87 is connected to the gate of n-channel MOS transistor 84. The n-channel MOS transistor and comparator of voltage adjustment circuits 41F-42F are connected in the same way as in voltage adjustment circuit 40F.

NOT circuit 87 inverts gate control signal V72 and outputs inverted gate control signal V87. NOT circuit 88 inverts gate control signal V73, and generates inverted gate control signal V88. NOT circuit 89 inverts gate control signal V74, and outputs gate control signal V89.

The n-channel MOS transistors 84-86 are turned on/off by the inverted gate control signals V87-V89 applied to the gates thereof. This on/off operation of the n-channel MOS transistor 84-86 is opposite phase to the on/off operation of the n-channel MOS transistors 75-77, respectively.

When cathode voltage V36C is greater than specific voltage V71, voltage adjustment circuit 40F sets the adjustment voltage V40F to the on voltage of n-channel MOS transistor 84, and when cathode voltage V36C is lower than specific voltage V71, sets the adjustment voltage V40F to the on voltage of n-channel MOS transistor 75. Voltage adjustment circuits 41F-42F likewise adjust adjustment voltages V41F-V42F.

The on resistance of n-channel MOS transistors 84-86 is set higher than the on resistance of n-channel MOS transistor 75-77, respectively. For example, if the on resistance of n-channel MOS transistors 84-86 is equal to the resistance of resistors 78-80 in FIG. 6 (such as 4Ω), light-emitting element drive device 200F operates identically to the foregoing light-emitting element drive device 200E and has the same effect.

### Second Variation of Embodiment 2

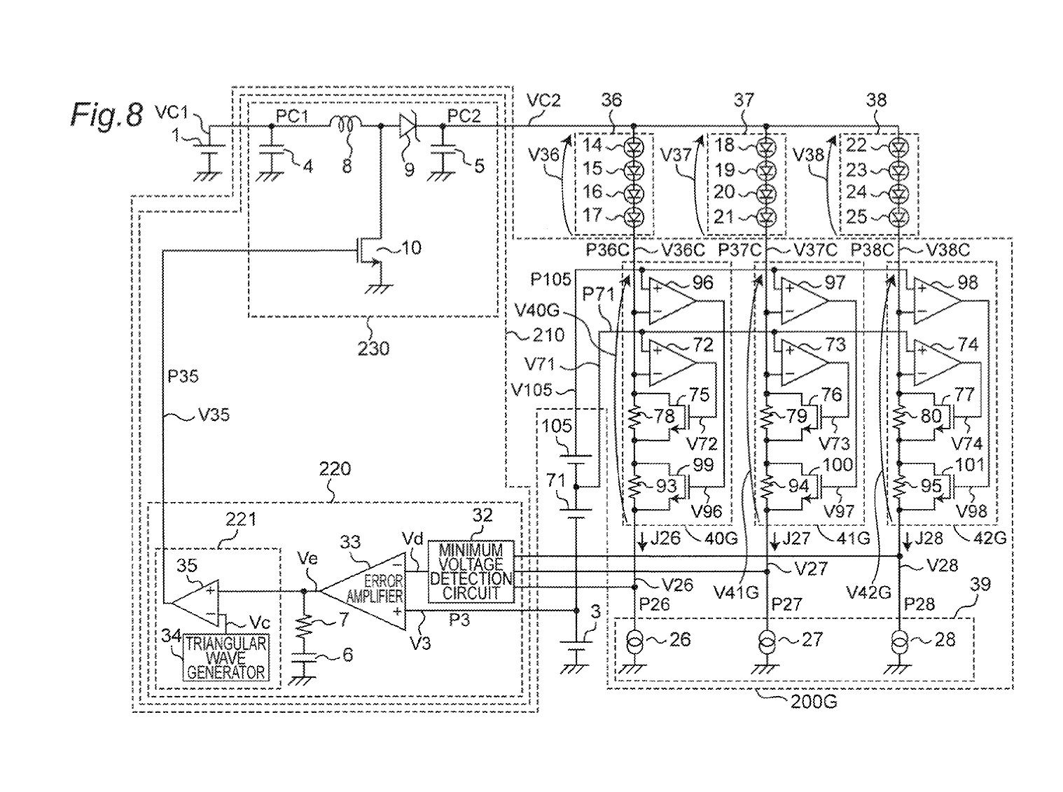

FIG. 8 is a circuit diagram showing the configuration of light-emitting element drive device 200G. Light-emitting element drive device 200G differs from the light-emitting element drive device 200E shown in FIG. 6 by using voltage adjustment circuits 40G, 41G, 42G instead of voltage adjustment circuits 40E-42E, respectively, and by having an additional voltage source path P105 and voltage source 105 as shown in FIG. 8.

In addition to the components of voltage adjustment circuit 40E described above, voltage adjustment circuit 40G includes n-channel MOS transistor 99, resistor 93, and comparator 96. In addition to the components of voltage adjustment circuit 41E described above, voltage adjustment circuit 41G includes n-channel MOS transistor 100, resistor 94, and comparator 97. In addition to the components of voltage adjustment circuit 42E described above, voltage adjustment circuit 42G includes n-channel MOS transistor 101, resistor 95, and comparator 98.

In voltage adjustment circuit 40G, the source of n-channel MOS transistor 99 is connected to one end of resistor 93 and detection path P26, and the drain is connected to the other end of resistor 93, one end of resistor 78, and the source of n-channel MOS transistor 75. The drain of n-channel MOS transistor 75 is connected to the other end of resistor 78, the inverted input node of comparator 72, the inverted input node of comparator 96, and cathode path P36C. The non-inverted input node of comparator 72 is connected to voltage source path P71, and the non-inverted input node of comparator 96 is connected to voltage source path P105. The output node of comparator 72 is connected to the gate of n-channel MOS transistor 75, and the output node of comparator 96 is connected to the gate of n-channel MOS transistor 99. The two n-channel MOS transistors and two comparators in voltage adjustment circuits 41G-42G are connected in the same way as those of voltage adjustment circuit 40G.

Voltage source 105 is connected between voltage source path P105 and voltage source path P71, and by producing a specific voltage outputs specific voltage V105 denoting the voltage sum of specific voltage V71 and the specific voltage of voltage source 105 to voltage source path P105.

The operation of comparator 96 and n-channel MOS transistor 99 is the same as the operation of comparator 72 and n-channel MOS transistor 75. That is, comparator 96 receives cathode voltage V36C through the inverted input node, receives the specific voltage V105 from voltage source path P105 through the non-inverted input node, and generates gate control signal V96 denoting the result of comparing cathode voltage V36C and specific voltage V105. The n-channel MOS transistor 99 is switched on/off by the gate control signal V96 applied to the gate thereof. Likewise, comparator 97 generates gate control signal V97, and n-channel MOS transistor 100 is turned on/off by gate control signal V97. Likewise, comparator 98 generates gate control signal V98, and n-channel MOS transistor 101 is turned on/off by gate control signal V98.

In voltage adjustment circuit 40G, when cathode voltage V36C is lower than specific voltage V105 and V71, n-channel MOS transistors 99 and 75 are on. In this situation adjustment voltage V40G is the product of the sum of the on resistances of n-channel MOS transistors 99 and 75 and drive current J26.

When cathode voltage V36C is lower than specific voltage V105 and greater than specific voltage V71, n-channel MOS transistor 99 is on and n-channel MOS transistor 75 is off. In this case, adjustment voltage V40G is equal to the product of the sum of the on resistance of n-channel MOS transistor 99 and resistance 78 and drive current J26. When cathode voltage V36C is greater than specific voltage V105 and V71, n-channel MOS transistors 99 and 75 are off. In this case, adjustment voltage V40G is the product of the sum of the resistances of resistors 93 and 78 and drive current J26. Voltage adjustment circuits 41G-42G adjust adjustment voltages V41G-V42G in the same way as voltage adjustment circuit 40G.

By thus increasing the number of steps to which adjustment voltages V40G, V41G, V42G can be set compared with light-emitting element drive device 200E, light-emitting element drive device 200G can also absorb differences in total forward voltages V36-V38. As a result, light-emitting element drive device 200G can further reduce end voltages V26-V28.

### Embodiment 3

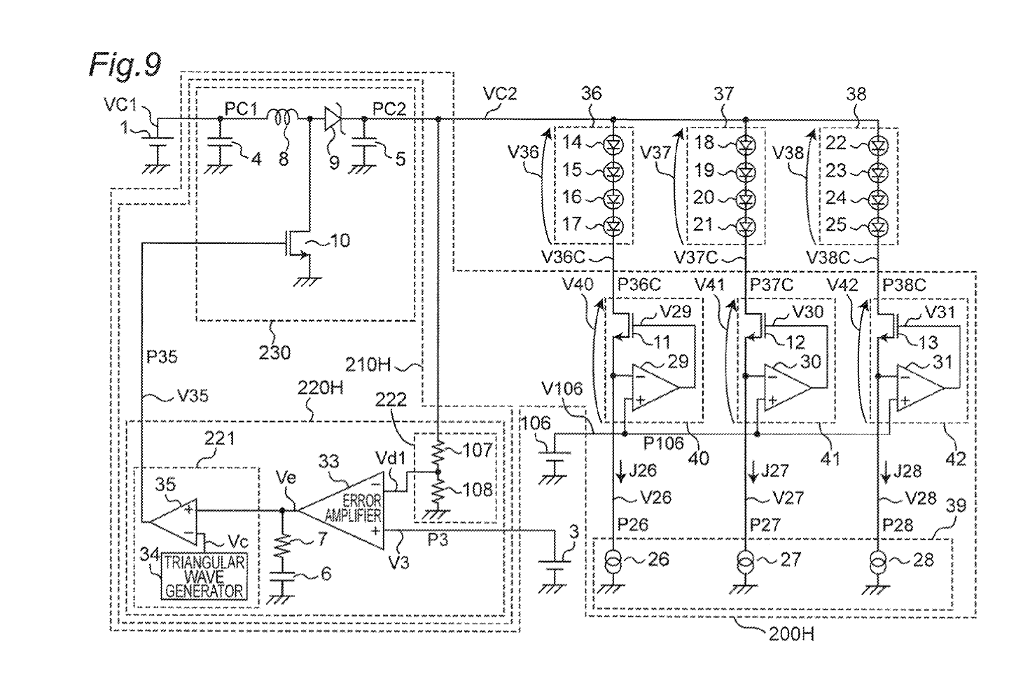

FIG. 9 is a circuit diagram showing the configuration of light-emitting element drive device 200H. Light-emitting element drive device 200H differs from the light-emitting element drive device 200 shown in FIG. 1 as follows. First, drive voltage generating circuit 210H replaces drive voltage generating circuit 210. Second, the path from output path PC2 to drive voltage generating circuit 210H is changed from the path from detection paths P26-P28 to the drive voltage generating circuit 210. Third, voltage source path P106 is changed from voltage source path P2. In addition, voltage source 106 in FIG. 9 is changed from voltage source 2 in FIG. 1. Other aspects of the configuration, operation, and effect of this third embodiment are the same as the first embodiment, and further description is omitted.

Voltage source 106 is connected between voltage source path P106 and ground, and generates and outputs specific voltage V106 to voltage source path P106. The non-inverted input nodes of operating amplifiers 29-31 are connected to voltage source path P106. The operating amplifier 29 receives specific voltage V106 from the voltage source path P106 through the non-inverted input node, and generates gate control signal V29 by amplifying the difference of specific voltage V106 minus end voltage V26. The other operating amplifiers 29-31 operate in the same way as operating amplifier 29.

Drive voltage generating circuit 210H has converter control circuit 220H instead of the converter control circuit 220 in FIG. 1. Converter control circuit 220H has a feedback circuit 222 instead of minimum voltage detection circuit 32.

The feedback circuit 222 includes resistors 107 and 108. One end of resistor 107 is connected to output path PC2, and the other end is connected to one end of resistor 108 and the inverted input node of error amplifier 33. The other end of resistor 108 goes to ground. The feedback circuit 222 divides drive voltage VC2 at a specific ratio and outputs partial voltage Vd1. The error amplifier 33 receives partial voltage Vd1 through the inverted input node, receives specific voltage V3 from voltage source path P3 through the non-inverted input node, and amplifies the difference of specific voltage V3 minus partial voltage Vd1 to produce error signal Ve.

Note that in the following example the path through light-emitting element group 36 is the path on which the total forward voltage is greatest of total forward voltages V36-V38 (corresponding to the minimum voltage path of the first embodiment). In addition, the resistance of resistor 107 and 108 is R107 and R108, respectively, the minimum operating end voltage is VMIN, and the on resistance of n-channel MOS transistor 11 is RON.

If in this configuration specific voltage V106 is set as shown in equation (8), end voltages V26-V28 will be greater than or equal to minimum operating end voltage VMIN and near minimum operating end voltage VMIN.

In addition, if drive voltage generating circuit 210H adjusts drive voltage VC2 as shown in equation (9), the desired output can be obtained from light-emitting element groups 36-38, and power loss can be reduced in current drive circuits 26-28. That is, if resistances R107, R108 and specific voltage V3 are set so that equation (10) is satisfied, drive voltage VC2 can be controlled as shown in equation (9) by means of feedback control in the drive voltage generating circuit 210H.

V106≧VMIN (8)

VC2≧V36+RON×J26+VMIN (9)

VC2=V3×(R107+R108)/R108 (10)

Note that the configuration shown in FIG. 9 varies the configuration shown in FIG. 1, but the same changes can be applied to the configurations shown in FIG. 2 to FIG. 8 with the same effect.

### Generalization of the Embodiments

As described above, with the light-emitting element drive device and light-emitting device according to the invention, the voltage adjustment circuit can absorb differences in the total forward voltages of N light-emitting element groups that differ greatly from each other due to variations in the forward voltages of the light-emitting elements. As a result, the voltage adjustment circuit can control the end voltages of the N current drive circuits to the minimum voltage required to achieve the desired output from the light-emitting element groups. Because a voltage that is higher than necessary is therefore not applied to the ends of the current drive circuits, power loss in the current drive circuits is extremely low and the power consumption of the current drive circuits can be reduced to the minimum required.

When N current drive circuits are rendered on a single semiconductor substrate, the heat output of the semiconductor chip can be reduced, the quality of the semiconductor chip can be improved, and devices including more current drive circuits can be rendered on the same semiconductor substrate. Furthermore, because there is no need to selectively differentiate the light-emitting elements, such selection steps can be eliminated and the cost the light-emitting element groups can be reduced, and the cost of a light-emitting device include a light-emitting element drive device can be reduced.

In addition to variations in the forward voltage of the light-emitting elements rendering the light-emitting element groups, the total forward voltages of the N light-emitting element groups may also differ from each other in the following cases. First, when the N drive currents differ from each other. Second, when the number of light-emitting elements connected in series differs in each of the N light-emitting element groups. Third, when types of light-emitting elements with different forward voltages are used in each of the N light-emitting element groups. Fourth, when there is a difference in the ambient temperatures of the N light-emitting element groups. Even in such situations, the N total forward voltages differ from each other, and the effect described above can be achieved by the operation of the voltage adjustment circuits.

The drive current generated by one current drive circuit tends to change dependent upon the end voltages. For example, as the end voltage rises, the drive current tends to increase. However, because the voltage adjustment circuit connected to the current drive circuit can suppress variation in the end voltage, the relative precision of the drive current output by one current drive circuit

In addition, because the minimum end voltage of the N current drive circuits is detected from the end voltages of the current drive circuits that are on, the drive current tends to change depending on the specific characteristics of the on current drive circuits. However, regardless of which of the N current drive circuits is on, the voltage adjustment circuit connected to the current drive circuit that is on can suppress variation in the end voltage. As a result, the absolute precision of the drive currents can be improved in the N current drive circuits.

A light-emitting device containing the light-emitting element drive device according to the invention includes backlights for liquid crystal display devices used in flat panel televisions and notebook computers, and lighting fixtures including indoor room lighting, headlights, and other vehicle lighting fixtures. A light-emitting element drive device according to the invention is particularly useful as an LED driver chip for driving such light-emitting devices.

Note that numbers used in the foregoing description of the invention are used by way of example only to describe the invention in detail, and the invention is not limited thereto. Logic levels denoted as high and low are also used by way of example only to describe the invention, and it will be obvious that by changing the configuration of the logic circuits the same operation and effect can be achieved by logic levels different from those cited in the foregoing embodiments. Yet further, some components that are rendered by hardware can also be rendered by software, and some components that are rendered by software can also be rendered by hardware. Furthermore, some of the elements described in the foregoing embodiments can be reconfigured in combinations that differ from the foregoing embodiments to achieve the particular effects of such different configurations while not departing from the scope of the invention.

### INDUSTRIAL APPLICABILITY

The invention can be used in light-emitting element drive devices and light-emitting devices.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

1. A light-emitting element drive device that drives N (where N is an integer of 2 or more) light-emitting element groups each including one or more light-emitting element, comprising:
a drive voltage generating circuit that supplies a drive voltage to the N light-emitting element groups;
N current drive circuits that respectively drive the N light-emitting element groups; and
N or fewer voltage adjustment circuits that are disposed to paths between the output of the drive voltage generating circuit and the N current drive circuits, connected in series to the N light-emitting element groups, and adjust the end voltages of the current drive circuits.

2. The light-emitting element drive device described in claim 1, further comprising:
a minimum voltage detection circuit that detects the lowest voltage of the end voltages of the N current drive circuits;
wherein the signal path of the minimum voltage detected by the minimum voltage detection circuit is a feedback path of the drive voltage generating circuit.

3. The light-emitting element drive device described in claim 1, wherein:
the N or fewer voltage adjustment circuits each include at least an operating amplifier and a transistor,
the transistor is connected in series with the N light-emitting element groups on a path between the output of the drive voltage generating circuit and the N current drive circuits; and
a feedback circuit is rendered by inputting a first specific voltage that can change a set voltage for each operating amplifier to one input of the operating amplifier,
connecting the other input of the operating amplifier to a path between the N light-emitting element groups and the N current drive circuits, and
controlling the transistor by means of the output of the operating amplifier.

4. The light-emitting element drive device described in claim 3, wherein:
the drive voltage generating circuit includes an error amplifier to which a second specified voltage is input to one input and the output signal of the minimum voltage detection circuit is input to another input, and
the drive voltage generating circuit sets the first specified voltage greater than or equal to a third specified voltage that is determined based on the second specified voltage and is the lowest voltage of the end voltages of the N current drive circuits detected by the minimum voltage detection circuit.

5. The light-emitting element drive device described in claim 1, wherein:
the N or fewer voltage adjustment circuits each include at least a comparator, a transistor, and a resistance component (or diode),
the transistor and resistance component (or diode) are connected parallel to each other and connected in series with the N light-emitting element groups on a path between the drive voltage generating circuit and the N current drive circuits, and
the transistor is controlled by output from the comparator, of which one input is a path between the N light-emitting element groups and the N current drive circuits and the other input is a fourth specific voltage.

6. The light-emitting element drive device described in claim 1, wherein:
the N or fewer voltage adjustment circuits each include at least a comparator and a first transistor and a second transistor having a different on resistance,
the first transistor and second transistor connected parallel to each other and connected in series with the N light-emitting element groups on a path between the drive voltage generating circuit and the N current drive circuits, and
the first transistor and second transistor are, or one of the first transistor and second transistor is, controlled by output from the comparator of which the path between the N light-emitting element groups and the N current drive circuits is one input and the other input is a fourth specific voltage.

7. The light-emitting element drive device described in claim 5, wherein:
the drive voltage generating circuit includes an error amplifier to which the second specified voltage is input to one input and the output signal of the minimum voltage detection circuit is input to another input, and
the drive voltage generating circuit sets the fourth specified voltage greater than a third specified voltage that is determined based on the second specified voltage and is the lowest voltage of the end voltages of the N current drive circuits detected by the minimum voltage detection circuit.

8. A light-emitting device comprising:
N (where N is an integer of 2 or more) light-emitting element groups each including one or more light-emitting element; and
the light-emitting element drive device described in claim 1.
